(19) United States
(12) Patent Application Publication
(10) Pub. No.: US 2024/0015117 A1
(43) Pub. Date: Jan. 11, 2024

(54) METHOD AND SYSTEM FOR PROVIDING CHATBOT SERVICE

(71) Applicant: SAMSUNG SDS CO., LTD., Seoul (KR)

(72) Inventors: Kyeong Soo JEONG, Seoul (KR); Ji Hyun MOON, Seoul (KR); Yoon Jeong CHANG, Seoul (KR); Da Han JEONG, Seoul (KR)

(73) Assignee: SAMSUNG SDS CO., LTD., Seoul (KR)

(21) Appl. No.: 18/216,145

(22) Filed: Jun. 29, 2023

(30) Foreign Application Priority Data
Jul. 6, 2022 (KR) 10-2022-0083153

(51) Int. Cl. H04L 51/02; G06F 16/332; G06F 16/31

(52) U.S. Cl. CPC H04L 51/02; G06F 16/3329; G06F 16/313

(57) ABSTRACT

Provided is a chatbot service providing method and a system, to which the method is applied. The chatbot service providing method according to an example embodiment includes obtaining a plurality of contents for a chatbot service, generating grouping information for the plurality of contents by grouping the plurality of contents based on a similarity between contents, generating index information for the plurality of contents, and providing the chatbot service using the grouping information and the index information.

### CROSS-REFERENCE TO RELATED APPLICATION

This application claims priority from Korean Patent Application No. 10-2022-0083153, filed on Jul. 6, 2022, in the Korean Intellectual Property Office, the disclosure of which is incorporated herein by reference in its entirety.

### BACKGROUND

### 1. Field

The present disclosure relates to a method for providing a chatbot service and a system to which the method is applied.

### 2. Description of the Related Art

User support by human resources incurs significant human costs. Accordingly, recently, in almost all fields providing user support services, chatbots that automatically perform Q&A with users are being used.

Conventionally, in order to compose chatbot contents, a manager had to classify the chatbot directly, and the manager had to directly train the chatbot using a large amount of spoken languages to improve the accuracy of the chatbot's response. As a result, a lot of time and cost was consumed in training the chatbot.

In addition, conventionally, since the chatbot has a structure, in which the chatbot outputs the data that the manager inputted and configured as it is, there is a problem in that the refined category and content should be registered in advance (e.g., the manager's convenience is reduced).

Therefore, there is a need for a method that can automatically perform a series of chatbot construction processes such as category classification and chatbot generation only by registering unstructured content without requiring learning of spoken language.

### SUMMARY

A technical problem to be achieved through some embodiments of the present disclosure is to provide a method for receiving unstructured content and automatically classifying categories and generating chatbots.

Another technical problem to be achieved through some embodiments of the present disclosure is to provide a method for accurately measuring similarity between input unstructured content.

Another technical problem to be achieved through some embodiments of the present disclosure is to provide a method for automatically grouping similar contents based on similarity between input unstructured contents.

Another technical problem to be achieved through some embodiments of the present disclosure is to provide a method for performing a flexible Q&A according to a user's input type.

The technical problems of the present disclosure are not limited to the above-mentioned technical problems, and other technical problems not mentioned will be clearly understood by those skilled in the art from the following description.

Aspects of the present disclosure for solving the problems provide a method performed by a computing system for providing a chatbot service. The method may include obtaining a plurality of contents for a chatbot service, generating grouping information for the plurality of contents by grouping the plurality of contents based on a similarity between contents, generating index information for the plurality of contents and providing the chatbot service using the grouping information and the index information.

In some embodiments, generating grouping information for the plurality of contents may include extracting a keyword included in the plurality of contents, calculating a frequency, in which each of the extracted keyword is included in the plurality of contents, generating a keyword vector for each of the plurality of contents based on the calculated frequency, calculating a similarity between the plurality of contents using the generated keyword vector and grouping content having the calculated similarity is equal to or greater than a reference value.

In some embodiments, the similarity may be calculated based on a cosine similarity between the generated keyword vectors.

In some embodiments, the grouping the content having the calculated similarity equal to or greater than the reference value may include grouping a plurality of first contents having the calculated similarity equal to or greater than a first reference value into a first group and grouping content having the calculated similarity equal to or greater than a second reference value among the plurality of first contents into a second group, which is a subgroup of the first group, the second reference value may be greater than the first reference value.

In some embodiments, the grouping into the second group may include grouping into the second group in response to determining that a number of the plurality of first contents is equal to or greater than a threshold value.

In some embodiments, the generating the index information may include extracting a keyword from a title of each of the plurality of contents and generating the index information by mapping the extracted keyword and titles of the plurality of contents.

In some embodiments, the index information may include an index keyword and a list of contents in a mapping relationship with the index keyword, and the providing the chatbot service may include receiving a question sentence from a user, extracting a keyword from the received question sentence, obtaining a list of contents corresponding to the extracted keyword by using the index information, and providing a response to the received question sentence based on the obtained list.

In some embodiments, the providing the response may include providing contents of content corresponding to the extracted keyword as the response when a number of contents included in the obtained list is one.

In some embodiments, the providing the chatbot service may include providing a list of content groups to a user based on the grouping information, receiving a selection input for an interest content group included in the provided list from the user and providing a list of contents belonging to the interest content group as a response in response to the selection input.

In some embodiments, the method may further include obtaining additional content for the chatbot service, updating the grouping information based on a similarity between the additional content and the plurality of contents and updating the index information to reflect the additional content.

In some embodiments, the grouping information may include a content group formed through the grouping and a name of the content group, and the generating the grouping information may include extracting a common keyword from titles of a plurality of contents belonging to the content group and setting it as the name of the content group.

Aspects of the present disclosure for solving the problems provide a system for providing a chatbot service. The system may include a memory, in which a chatbot service providing program is loaded and one or more processors configured to execute a chatbot service providing program loaded into the memory, the chatbot service providing program may include an instruction for obtaining a plurality of contents for a chatbot service, an instruction for generating grouping information for the plurality of contents by grouping the plurality of contents based on a similarity between contents, an instruction for generating index information for the plurality of contents and an instruction for providing the chatbot service using the grouping information and the index information.

In some embodiments, the instruction for generating grouping information for the plurality of contents may include an instruction for extracting a keyword included in the plurality of contents, an instruction for calculating a frequency, in which each of the extracted keyword is included in the plurality of contents, an instruction for generating a keyword vector for each of the plurality of contents based on the calculated frequency, an instruction for calculating a similarity between the plurality of contents by using the generated keyword vector and an instruction for grouping content having the calculated similarity equal to or greater than a reference value.

In some embodiments, the similarity may be calculated based on a cosine similarity between the generated keyword vectors.

In some embodiments, the instruction for grouping the content having the calculated similarity equal to or greater than the reference value may include an instruction for grouping a plurality of first contents having the calculated similarity equal to or greater than a first reference value into a first group and an instruction for grouping content having the calculated similarity equal to or greater than a second reference value among the plurality of first contents into a second group, which is a subgroup of the first group, the second reference value may be greater than the first reference value.

In some embodiments, the instruction for grouping into the second group may include an instruction for grouping into the second group in response to determining that a number of the plurality of first contents is equal to or greater than a threshold value.

In some embodiments, the instruction for generating the index information may include an instruction for extracting a keyword from a title of each of the plurality of contents and an instruction for generating the index information by mapping the extracted keyword and titles of the plurality of contents.

In some embodiments, the index information may include an index keyword and a list of contents in a mapping relationship with the index keyword, the instruction for providing the chatbot service may include an instruction for receiving a question sentence from a user, an instruction for extracting a keyword from the received question sentence, an instruction for obtaining a list of contents corresponding to the extracted keyword by using the index information and an instruction for providing a response to the received question sentence based on the obtained list.

In some embodiments, the instruction for providing the response may include an instruction for providing contents of content corresponding to the extracted keyword as the response when a number of contents included in the obtained list is one.

In some embodiments, the instruction for providing the chatbot service may include an instruction for providing a list of content groups to a user based on the grouping information, an instruction for receiving a selection input for an interest content group included in the provided list from the user and an instruction for providing a list of contents belonging to the interest content group as a response in response to the selection input.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates an exemplary environment, to which a chatbot service providing system according to an embodiment of the present disclosure may be applied;

FIG. 2 is an exemplary block diagram for describing a chatbot service providing system according to another embodiment of the present disclosure;

FIG. 3 is a flowchart of a chatbot service providing method according to another embodiment of the present disclosure;

FIG. 4 is a diagram for illustratively describing chatbot content that may be referred to in some embodiments of the present disclosure;

FIG. 5 is a flowchart for describing the similarity calculating step shown in FIG. 3 in more detail;

FIG. 6 is diagrams for describing the keyword frequency calculation step shown in FIG. 5 by way of example;

FIG. 7 is diagrams for describing the similarity calculation step shown in FIG. 5 by way of example;

FIG. 8 is a diagram for illustratively describing a result of performing the similarity calculating step shown in FIG. 5;

FIG. 9 is a flowchart for describing the content grouping step shown in FIG. 3 in more detail;

FIG. 10 is a diagram for describing the content grouping step shown in FIG. 3 by way of example;

FIG. 11 is a flowchart for exemplarily describing the content group name setting step shown in FIG. 9;

FIG. 12 is a flowchart for describing in detail the step of providing the chatbot service shown in FIG. 3;

FIG. 13 is a diagram for exemplarily describing the step of providing a chatbot service shown in FIG. 3; and

FIG. 14 is a hardware configuration diagram of a chatbot service providing system according to an embodiment of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will be defined by the appended claims and their equivalents.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Prior to description of various embodiments of the present disclosure, terms used in the following embodiments will be clarified.

In the following embodiments, ‘content’ may refer to data in the form of text used to enable a chatbot to perform Q&A with a user. The content may include, for example, a title area and a contents area. In the art, content may be used interchangeably with terms such as chatbot content and chatbot data.

Hereinafter, several embodiments of the present disclosure are described with reference to the drawings.

FIG. 1 is a diagram illustrating an environment, to which a chatbot service providing system according to an embodiment of the present disclosure may be applied.

As shown in FIG. 1, the chatbot service providing system 100 according to the present embodiment can implement a chatbot service providing method through interaction with the manager terminal 200 and the user terminal 300.

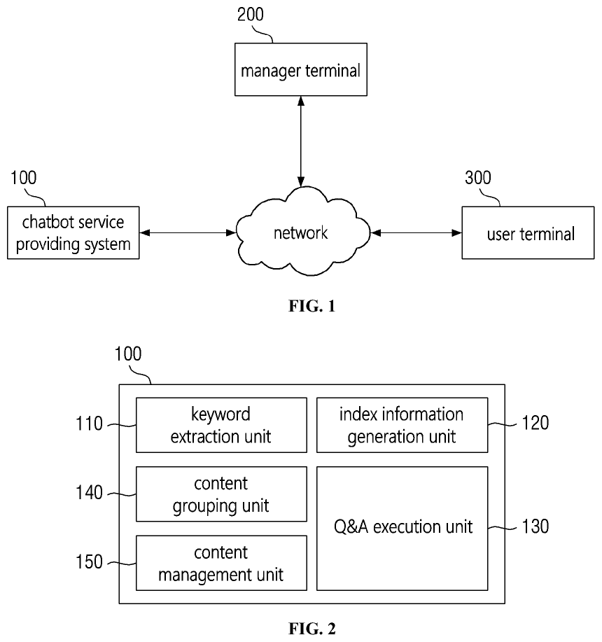

Hereinafter, each component shown in FIGS. 1 and 2 will be described in more detail.

The manager terminal 200 is a terminal that manages the chatbot service. The manager terminal 200 may register chatbot content in the chatbot service providing system 100. Here, the chatbot content may refer to data in the form of text used to allow the chatbot to perform Q&A with the user.

In addition, the manager terminal 200 may provide a similarity reference value, which is a criterion for grouping chatbot content, as an input to the chatbot service providing system 100 according to an embodiment of the present disclosure.

The user terminal 300 may transmit the user's question to the chatbot service providing system 100 in response to the user's input. Based on the transmitted user's question, the chatbot service providing system 100 may perform Q&A with the user. The Q&A may mean that the chatbot service providing system 100 outputs chatbot content corresponding to the user's question in response to the user's question. The outputted chatbot content may be displayed to the user through the user terminal 300.

The user terminal 300 may have a specific display device and input device in order to perform Q&A with the chatbot. The user terminal 300 may transmit the user's question to the chatbot service providing system 100, and any device capable of displaying the content output by the chatbot service providing system 100 may be used.

The chatbot service providing system 100 may group the received content based on the similarity between the contents in response to receiving the content from the manager terminal 200 according to an embodiment of the present disclosure. As shown in FIG. 2, this may be performed in the content grouping unit 140, and the input content may be stored in the content management unit 150.

In order to help understanding of the present disclosure, a set of contents generated as a result of grouping contents will be described as a content group.

The content may be in a Comma-Separated Values (CSV) format, which is a set of text including a title and contents of the content. In addition, any format can be allowed as long as it can express text including the title and contents of the content, such as a web document such as HTML (Hyper Text Markup Language) or XML (eXtensible Markup Language).

In addition, the chatbot service providing system 100 may generate grouping information based on the content group. The grouping information may be used to perform Q&A with the user. The step of generating the grouping information may be performed in the content grouping unit 140 shown in FIG. 2, and a method of generating the grouping information will be described later in detail.

The chatbot service providing system 100 may generate index information for the content. Here, the index information may be information obtained by mapping a keyword included in the content with a title of the content. In addition, the chatbot service providing system 100 may obtain a content list corresponding to a keyword included in a user question based on the generated index information. The step of generating the index information may be performed by the index information generation unit 120 shown in FIG. 2.

The chatbot service providing system 100 may calculate a similarity between the input contents. Here, the similarity between the contents may be calculated based on the frequency, in which each keyword extracted from the contents is included in the contents. The method of the chatbot service providing system 100 for calculating the similarity will be described later in detail.

In addition, in order to calculate the similarity, the chatbot service providing system 100 may extract a keyword from the content. The operation of extracting the keyword may be performed by the keyword extraction unit 110 shown in FIG. 2, and a detailed method of extracting the keyword will be described later.

The chatbot service providing system 100 may provide a chatbot service using the grouping information and the index information. Here, the chatbot service may mean providing a response to a question input from a user terminal, and the corresponding operation may be performed by the Q&A execution unit 130 shown in FIG. 2. A detailed method of providing the chatbot service will be described later.

So far, the configuration and operation of the chatbot service providing system 100 and exemplary environments, to which the chatbot service providing system 100 can be applied, have been described with reference to FIGS. 1 and 2. It will be understood that the chatbot service providing system 100 and the user terminal 300 operate according to a server-client model. However, in some embodiments, the system may be configured in a client stand-alone method without a server. In this case, it may be understood that the operation performed by the chatbot service providing system 100 is performed in the user terminal 300.

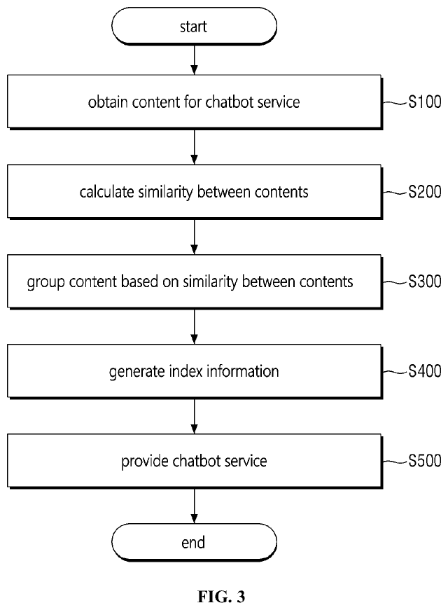

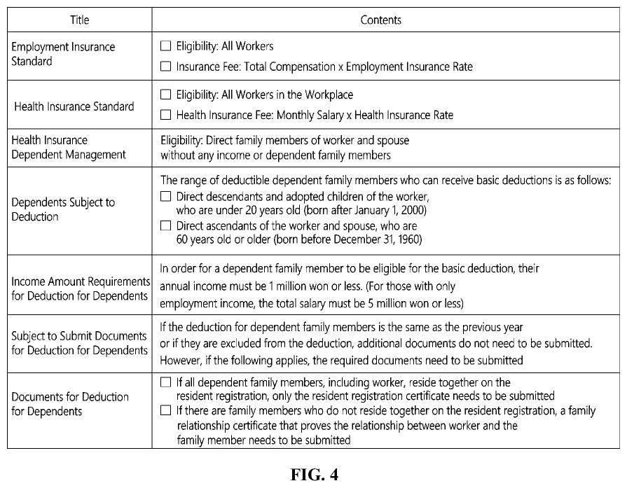

Referring to FIGS. 3 to 13, a chatbot service providing method according to another embodiment of the present disclosure will be described in more detail. Hereinafter, steps to be described in some flowcharts may be understood to be performed by the chatbot service providing system 100 unless otherwise specified.

FIG. 3 is a flowchart of a method for providing a chatbot service according to this embodiment.

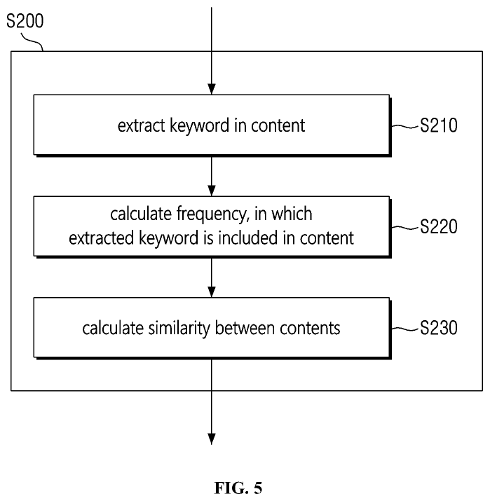

In step S100 shown in FIG. 3, the chatbot service providing system 100 may obtain a plurality of contents for the chatbot service from the manager terminal. For a more detailed description of the plurality of contents, it will be described with reference to FIG. 4.

Referring to FIG. 4, the content may include, for example, a title and contents of the content. However, the scope of the present disclosure is not limited thereto.

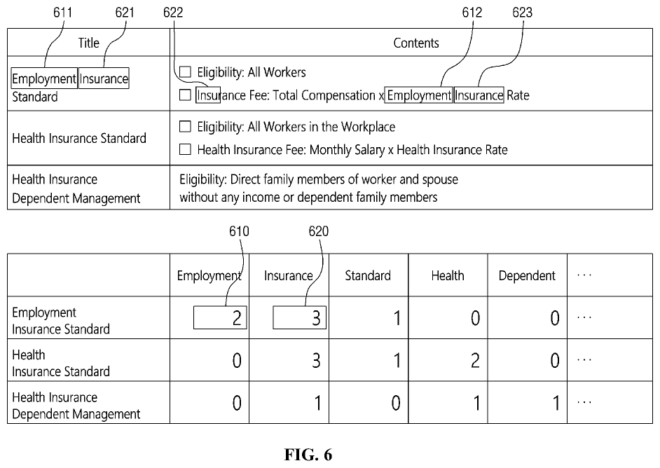

Next, in step S200, the chatbot service providing system may calculate a similarity between the obtained plurality of contents. In order to describe the step of calculating the similarity in more detail, it will be described with reference to FIGS. 5 to 8.

In step S210 shown in FIG. 5, the chatbot service providing system 100 may extract keywords included in the content. Here, the keyword may mean, for example, a morpheme whose part of speech is a noun in the title and contents of the content.

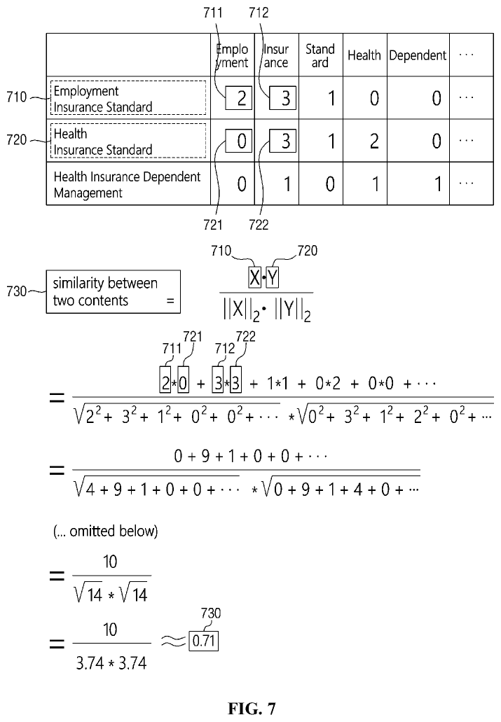

In some embodiments related to step S210, in order to perform the step of extracting the keyword, the chatbot service providing system 100 may perform morphological analysis on the title and contents of the content. More specifically, the keyword extraction unit 110 of the chatbot service providing system 100 may extract morphemes whose parts of speech are nouns through morpheme analysis of the title and contents of the content. The keyword extraction step S210 will be described in more detail with reference to FIG. 6.

Referring to FIG. 6, for example, since ‘employment’ morphemes 611 and 612 and ‘insurance’ morphemes 621-623 in the title (‘employment insurance standard’) and contents of ‘employment insurance standard’ content correspond to nouns, they can be extracted as keywords by the chatbot service system 100.

Next, in step S220, the chatbot service providing system 100 may calculate the frequency, in which the extracted keyword is included in the content. For example, referring to FIG. 6, since there are a total of two ‘employment’ keywords included in the title and contents of ‘employment insurance standard’ content, the frequency of the keyword ‘employment’ being included in the corresponding content can be calculated as two.

In some embodiments related to step S220, the chatbot service providing system 100 may generate a keyword vector for each content based on a frequency, in which the extracted keyword is included in each content. The step of generating the keyword vector will be described in more detail with reference to FIG. 6.

For example, referring to FIG. 6, the element in row 1 and column 1 of the keyword vector may be the frequency 610, in which the keyword ‘employment’ is included in ‘employment insurance standard’ content. Similarly, the element in row 1 and column 2 may be the frequency 620, in which the keyword ‘insurance’ is included in the ‘employment insurance standard’ content. As such, the keyword vector may be a vector having a frequency, in which each of the extracted keywords is included for each content, as an element.

Next, in step S230, the chatbot service providing system 100 may calculate a similarity between contents based on the frequency, in which the calculated keyword is included in the contents. The step of calculating the similarity will be described in detail with reference to FIG. 7.

In some embodiments related to step S230, the chatbot service providing system 100 may calculate the similarity of the content pairs of all cases among the plurality of contents. The similarity may have the form of a real number existing between 0 and 1.

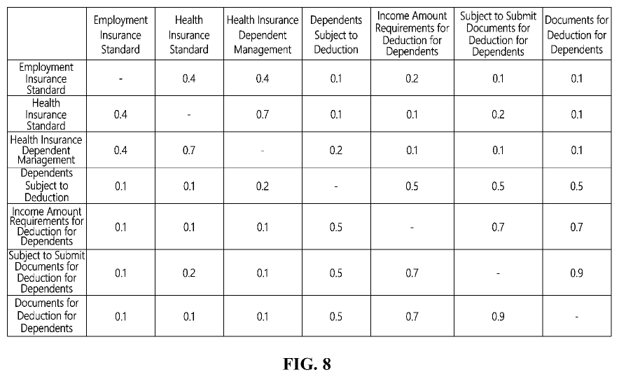

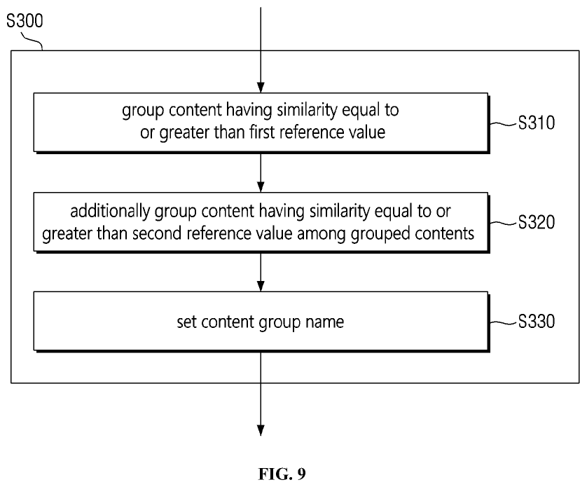

For example, when the chatbot service providing system 100 receives three contents, referring to the table of FIG. 7, the similarity between the ‘employment insurance standard’ content and the ‘health insurance standard’ content, the similarity between the ‘employment insurance standard’ content and the ‘health insurance dependent management’ content, and the similarity between the ‘health insurance standard’ content and the ‘health insurance dependent management’ content may all be calculated. A result of performing the step of calculating the similarity for the content pair can be clearly understood by referring to FIG. 8.

In some embodiments related to step S230, the chatbot service providing system 100 may calculate the similarity of the content pair based on the cosine similarity. The calculation method using the cosine similarity will be described with reference to FIG. 7.

Referring to FIG. 7, a similarity 730 between two contents may be calculated by the calculation equation (i.e., cosine similarity) shown in FIG. 7. In order to help understanding of the present disclosure, an example of calculating the similarity between the ‘employment insurance standard’ content 710 and the ‘health insurance standard’ content 720 will be described. The variable X of the calculation equation shown in FIG. 7 means a keyword vector for the ‘employment insurance standards’ content, and the variable Y means a keyword vector for the health insurance standards' content.

As exemplified by the keyword ‘employment’ in FIG. 7, the value multiplied by the frequency 711 that the keyword corresponding to column 1 of the keyword vector is included in the ‘employment insurance standard’ content and the frequency 721 that the keyword corresponding to column 1 of the keyword vector is included in the ‘health insurance standard’ content, and as exemplified by the keyword ‘insurance,’ the value multiplied by the frequency 712 that the keyword corresponding to column 2 of the keyword vector is included in the ‘health insurance standard’ content and the frequency 722 that the keyword corresponding to column 2 of the keyword vector is included in the ‘health insurance standard’ content are summed together. Also, the same operation is performed for elements of other keyword vectors below. As a result of performing this operation, the similarity 730 between the ‘employment insurance standard’ content and the ‘health insurance standard’ content can be calculated.

That is, when the number of keywords extracted from the input contents is N, the value of the numerator of the calculation equation can be obtained by calculating the equation K₁*L₁+K₂*L₂+ . . . +Kₙ*Lₙ for the frequency K, in which each keyword is included in the first content of a content pair to be calculated, and the frequency L, in which each keyword is included in the second content of a content pair to be calculated.

In addition, the value of the denominator of the above calculation equation can be obtained by calculating the equation \sqrt{K₁²+K₂²+K₃²+ . . . +Kₙ²}+\sqrt{L₁²+L₂²+L₃²+ . . . +Lₙ²}.

According to this embodiment, the similarity between unstructured contents composed of a vast amount of text can be accurately calculated as a quantitative value. Further, the similarity between contents expressed as quantitative values can be widely applied in other technical fields that utilize text analysis.

So far, the method of the chatbot service providing system 100 for calculating the similarity between a plurality of contents has been described in detail.

The description continues with reference to FIG. 3 again.

In S300 of FIG. 3, the chatbot service providing system 100 may group a plurality of contents based on the similarity between the calculated contents. The step of grouping the plurality of contents will be described in detail with reference to FIGS. 9 to 11.

Referring to FIG. 9, in step S310, the chatbot service providing system 100 may group content having a similarity equal to or greater than a first reference value. Here, the first reference value may be predetermined by a manager or the chatbot service providing system 100.

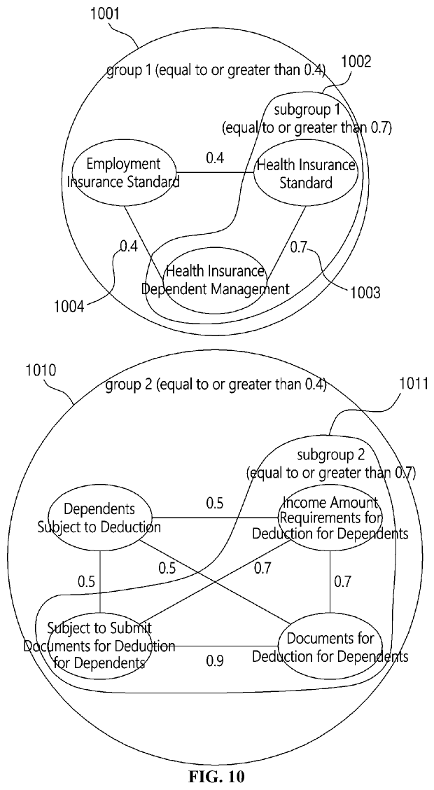

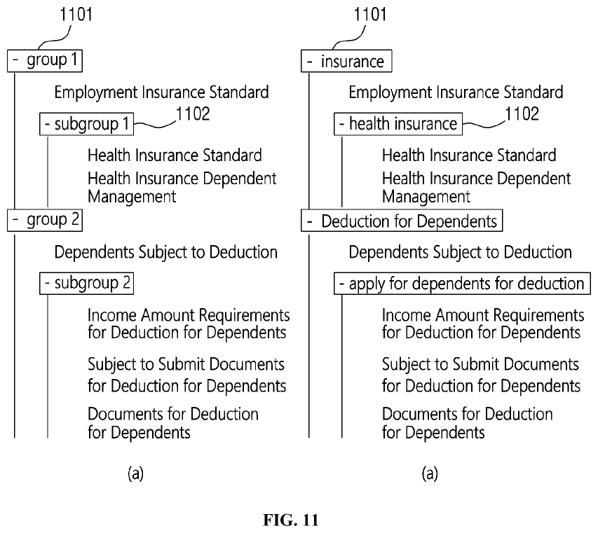

Referring to the table of similarities between the contents of FIG. 8 and FIG. 10, for example, when the first reference value is determined to be 0.4, since the similarity between the ‘employment insurance standard’ content, the ‘health insurance standard’ content, and the ‘health insurance dependent management’ content is equal to or greater than 0.4, they can be grouped into group 1 (1001). In addition, since the similarity between the ‘dependents subject to deduction’ content, ‘income amount requirements for deduction for dependents’ content, ‘subject to submit documents for deduction for dependents’ content and ‘documents for deduction for dependents’ content is equal to or greater than 0.4, the above contents also can be grouped into group 2 (1010).

On the other hand, since the similarity between the ‘employment insurance standard’ content, ‘dependents subject to deduction’ content, ‘income amount requirements for deduction for dependents’ content, ‘subject to submit documents for deduction for dependents’ content and ‘documents for deduction for dependents’ content is less than 0.4, the contents cannot be grouped.

In step S320, the chatbot service providing system 100 may additionally group content whose similarity is equal to or greater than a second reference value among the grouped contents. The additional grouping may mean generating a subgroup within the content group to include a plurality of contents having a similarity equal to or greater than a second reference value. In order to clarify the understanding of the present disclosure, a content group that can be obtained as a result of performing step S310 will be referred to as a first content group, and a content group that is a subgroup of the first content group will be referred to as a second content group.

For example, referring to FIG. 10, in response to the similarity 1003 between the ‘health insurance standard’ content and the ‘health insurance dependent management’ content among the contents included in group 1 (1001) being equal to or greater than the second reference value, the chatbot service providing system 100 may group the two contents into subgroup 1 (1002). On the other hand, since the similarity 1004 between the ‘employment insurance standard’ content and the ‘health insurance dependent management’ content is less than the second reference value, additional grouping may not be performed. In this case, the second reference value may be greater than the first reference value.

In some embodiments related to step S320, the chatbot service providing system 100 may automatically group some of the contents included in the first content group into the second content group in response to determining that the number of contents included in the first content group is equal to or greater than the threshold value.

Referring to FIG. 10, assuming that the second reference value for additional grouping of previously grouped content group 2 (1010) is 0.8, it can be clearly understood that additional grouping of contents included in group 2 (1010) is not performed. However, assuming that the number of contents corresponding to the threshold is 2, the chatbot service providing system 100 may generate subgroup 2 (1011) by lowering the second reference value to 0.7 in response to determining that the threshold is exceeded since the number of contents that are not additionally grouped in group 2 (1010) is 4.

Conventionally, chatbot managers had to register chatbot contents one by one after refining categories in advance. However, according to the present embodiment, since the chatbot manager only needs to register the chatbot contents, the manager's convenience can be greatly improved.

Subsequently, in step S330, the chatbot service providing system 100 may set the names of content groups. The step of setting the names of the content groups will be described in detail with reference to FIG. 11.

In some embodiments related to step S330, the chatbot service providing system 100 may set the names of the content groups based on the input received from the manager terminal 200. For example, referring to FIG. 11, the name of group 1 (1101) may be set as ‘insurance’ (1101) and the name of subgroup 1 (1102) may be set as ‘health insurance’ (1102) by the input of the manager terminal (200).

In some embodiments related to step S330, the chatbot service providing system 100 may automatically set a group name based on a common keyword included in a plurality of contents in the content group. According to the present embodiment, the chatbot service providing system 100 can automatically set a suitable name for the content group even without a manager's intervention. Accordingly, the convenience of the chatbot manager can be greatly improved.

So far, the method of the chatbot service providing system 100 for grouping a plurality of contents based on the similarity between the plurality of contents has described in detail.

The description continues with reference to FIG. 3 again.

In step S400, the chatbot service providing system 100 may generate index information by mapping a keyword extracted from a plurality of contents with a content title of each of the plurality of contents. The index information can be used to search for content corresponding to an input from the user in a step, in which the chatbot service providing system 100 performs Q&A with the user, which will be described later.

An operation of mapping a keyword extracted from the plurality of contents and a content title of each of the contents will be described as an example. For example, assuming that the keyword ‘employment’ has been extracted from a plurality of contents and that there is a content titled ‘employment insurance standard’, the chatbot service providing system 100 may map the keyword ‘employment’ and the corresponding content in response to determining that the title of the corresponding content includes the keyword ‘employment.’

User satisfaction with chatbot services largely depends on the ability to quickly provide appropriate responses to user questions. According to the present embodiment, the chatbot service providing system 100 can quickly search for content based on the index information and quickly provide a response, so that the chatbot service user's satisfaction can be maximized.

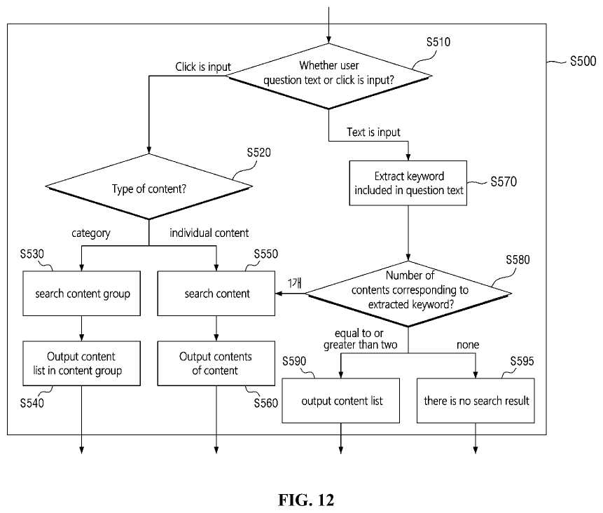

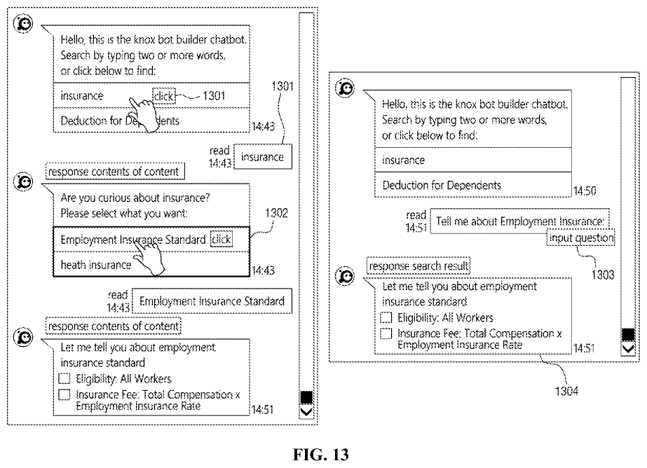

In step S500, the chatbot service providing system 100 may provide a chatbot service to the user. Here, provision of the chatbot service may mean that the chatbot service providing system 100 performs Q&A with the chatbot service user. The step of providing the chatbot service will be described in more detail with reference to FIGS. 12 and 13.

Referring to FIG. 12, in step S510, the chatbot service providing system 100 may evaluate the type of input corresponding to the user's question from the user terminal. The type of input corresponding to the user's question may be text input or mouse input.

In step S520, the chatbot service providing system 100 may evaluate the type of content (item) that was clicked on in the list in response to determining that the form of the user input corresponds to a click input to a previously provided list (e.g., a list of content titles, a list of content group names, etc.). The type of content may be, for example, a content group (i.e., category) or specific content.

In step S530, the chatbot service providing system 100 may search for contents belonging to the contents group in response to determining that the type of the clicked contents corresponds to the contents group. Furthermore, in step S540, the chatbot service providing system 100 may output a list of the searched contents. The list of the output contents may be displayed by a display device provided in the user terminal.

In some embodiments related to step S530, referring to FIG. 13, the chatbot service providing system 100, in response to the determining that the type of content corresponding to the user's click input 1301 for the keyword ‘insurance’ corresponds to the content group, may provide ‘employment insurance standard’ contents and ‘ health insurance standard’ content included in the content group 1302 related to the keyword ‘insurance’ to the user in the form of a list.

Here, as shown in FIG. 13, the keyword ‘insurance’ clicked by the user may be displayed in the form of a dialog box 1301 containing the text ‘insurance’ in the dialog window for Q&A between the user and the chatbot in the display device of the user terminal, such as the user inputs the text.

In step S550, the chatbot service providing system 100 may search the title and contents of the content corresponding to the user input in response to determining that the type of content corresponding to the user input corresponds to specific content. Furthermore, in step S560, the chatbot service providing system 100 may output the contents of the searched content. The contents of the output content may be displayed by a display device provided in the user terminal.

In some embodiments related to step S550, referring to FIG. 13, the chatbot service providing system 100 may search the title and contents of the ‘employment insurance standard’ contents in response to the determining that the user's input corresponds to the ‘ employment insurance standard’ content among the content list 1302 including ‘employment insurance standard’ content and ‘health insurance standard’ content. Next, the chatbot service providing system 100 may output the contents of the ‘employment insurance standard’ content searched above.

Next, in step S570, the chatbot service providing system 100 may extract keywords included in the user question in response to determining that the form of the user input corresponds to text input (i.e., question). The operation of extracting keywords can be clearly understood by referring to the descriptions related to some embodiments of step S210 above.

For example, referring to FIG. 13, the chatbot service providing system 100 may extract ‘employment’ and ‘insurance’, which have noun parts of speech, as keywords included in the user's question from the text 1303 of ‘Tell me about employment insurance’ by the user.

In step S580, the chatbot service providing system 100 may determine whether the number of contents searched for by the extracted keyword is plural. The content search may be performed through pre-generated index information.

According to some embodiments of the present disclosure, the chatbot service providing system 100 may provide contents of the searched content as a response in response to determining that the number of searched contents is one.

For example, referring to FIG. 13, the chatbot service providing system 100 may output the contents 1304 of the searched ‘employment insurance standard’ content in response to determining that the number of contents searched with the keyword extracted from the user question 1303 is one.

In step S590, the chatbot service providing system 100 may output the searched contents in a form of a list in response to determining that the number of searched contents is two or more.

In step S595, the chatbot service providing system 100 may provide a message informing that there is no search result as a response in response to determining that there is no content searched with the extracted keyword.

So far, the chatbot service providing method according to an embodiment of the present disclosure has been described in detail.

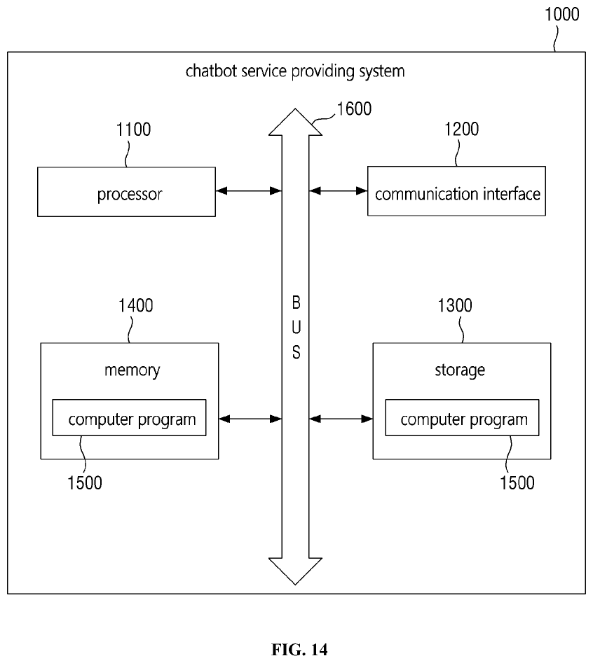

FIG. 14 is a hardware configuration diagram of a chatbot service providing system according to some embodiments of the present disclosure. The chatbot service providing system 1000 shown in FIG. 14 may indicate, for example, the chatbot service providing system 100 described with reference to FIG. 1.

The chatbot service providing system 1000 includes one or more processors 1100, a system bus 1600, a communication interface 1200, a memory 1400 that loads a computer program 1500 executed by the processor 1100, and a storage 1300 for storing the computer program 1500.

The processor 1100 controls the overall operation of each component of the chatbot service providing system 1000. The processor 1100 may perform an operation for at least one application or program for executing a method/operation according to various embodiments of the present disclosure. The memory 1400 may load one or more computer programs 1500 from storage 1300 to execute methods/operations according to various embodiments of the present disclosure.

The bus 1600 provides a communication function between components of the chatbot service providing system 1000.

The communication interface 1200 supports internet communication of the chatbot service providing system 1000.

The storage 1300 may non-temporarily store one or more computer programs 1500.

The computer program 1500 may include one or more instructions, in which methods/operations according to various embodiments of the present disclosure may be implemented. When the computer program 1500 is loaded into the memory 1400, the processor 1100 may execute the one or more instructions to perform methods/operations according to various embodiments of the present disclosure.

For example, the computer program 1500 may include instructions for performing an operation of obtaining a plurality of contents for a chatbot service, an operation of grouping the plurality of contents based on a similarity between contents, an operation of generating grouping information for the plurality of contents, an operation of generating index information for a plurality of contents and an operation of providing the chatbot service using the grouping information and the index information.

In some embodiments, the chatbot service providing system 1000 may be configured using one or more physical servers included in a server farm based on cloud technology such as a virtual machine.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the example embodiments without substantially departing from the principles of the present disclosure. Therefore, the disclosed example embodiments of the disclosure are used in a generic and descriptive sense only and not for purposes of limitation.

What is claimed is:

1. A method performed by a computing system for providing a chatbot service comprising:
obtaining a plurality of contents for a chatbot service;
generating grouping information for the plurality of contents by grouping the plurality of contents based on a similarity between contents;
generating index information for the plurality of contents; and
providing the chatbot service using the grouping information and the index information.

2. The method of claim 1, wherein the generating the grouping information for the plurality of contents comprises:
extracting a keyword included in the plurality of contents;
calculating a frequency, in which each of the extracted keyword is included in the plurality of contents;
generating a keyword vector for each of the plurality of contents based on the calculated frequency;
calculating a similarity between the plurality of contents using the generated keyword vector; and
grouping content having the calculated similarity is equal to or greater than a reference value.

3. The method of claim 2, wherein the similarity is calculated based on a cosine similarity between the generated keyword vectors.

4. The method of claim 2, wherein the grouping the content having the calculated similarity equal to or greater than the reference value comprises:
grouping a plurality of first contents having the calculated similarity equal to or greater than a first reference value into a first group; and
grouping content having the calculated similarity equal to or greater than a second reference value among the plurality of first contents into a second group, which is a subgroup of the first group, and
wherein the second reference value is greater than the first reference value.

5. The method of claim 4, wherein the grouping into the second group comprises:
grouping into the second group in response to determining that a number of the plurality of first contents is equal to or greater than a threshold value.

6. The method of claim 1, wherein the generating the index information comprises:
extracting a keyword from a title of each of the plurality of contents; and
generating the index information by mapping the extracted keyword and titles of the plurality of contents.

7. The method of claim 1, wherein the index information comprises an index keyword and a list of contents in a mapping relationship with the index keyword, and
wherein the providing the chatbot service comprises:
receiving a question sentence from a user;
extracting a keyword from the received question sentence;
obtaining a list of contents corresponding to the extracted keyword by using the index information; and
providing a response to the received question sentence based on the obtained list.

8. The method of claim 7, wherein the providing the response comprises:
providing contents of content corresponding to the extracted keyword as the response when a number of contents included in the obtained list is one.

9. The method of claim 1, wherein the providing the chatbot service comprises:
providing a list of content groups to a user based on the grouping information;
receiving a selection input for an interest content group included in the provided list from the user; and
providing a list of contents belonging to the interest content group as a response in response to the selection input.

10. The method of claim 1, further comprising:
obtaining additional content for the chatbot service;
updating the grouping information based on a similarity between the additional content and the plurality of contents; and
updating the index information to reflect the additional content.

11. The method of claim 1, wherein the grouping information comprises a content group formed through the grouping and a name of the content group, and
wherein the generating the grouping information comprises:
extracting a common keyword from titles of a plurality of contents belonging to the content group and setting it as the name of the content group.

12. A system for providing a chatbot service comprising:
a memory, in which a chatbot service providing program is loaded; and
one or more processors configured to execute a chatbot service providing program loaded into the memory,
wherein the chatbot service providing program comprises:
an instruction for obtaining a plurality of contents for a chatbot service;
an instruction for generating grouping information for the plurality of contents by grouping the plurality of contents based on a similarity between contents;
an instruction for generating index information for the plurality of contents; and
an instruction for providing the chatbot service using the grouping information and the index information.

13. The system of claim 12, wherein the instruction for generating the grouping information for the plurality of contents comprises:
an instruction for extracting a keyword included in the plurality of contents;
an instruction for calculating a frequency, in which each of the extracted keyword is included in the plurality of contents;
an instruction for generating a keyword vector for each of the plurality of contents based on the calculated frequency;
an instruction for calculating a similarity between the plurality of contents by using the generated keyword vector; and
an instruction for grouping content having the calculated similarity equal to or greater than a reference value.

14. The system of claim 13, wherein the similarity is calculated based on a cosine similarity between the generated keyword vectors.

15. The system of claim 13, wherein the instruction for grouping the content having the calculated similarity equal to or greater than the reference value comprises:
an instruction for grouping a plurality of first contents having the calculated similarity equal to or greater than a first reference value into a first group; and
an instruction for grouping content having the calculated similarity equal to or greater than a second reference value among the plurality of first contents into a second group, which is a subgroup of the first group, and
wherein the second reference value is greater than the first reference value.

16. The system of claim 15, wherein the instruction for grouping into the second group comprises:
an instruction for grouping into the second group in response to determining that a number of the plurality of first contents is equal to or greater than a threshold value.

17. The system of claim 12, wherein the instruction for generating the index information comprises:
an instruction for extracting a keyword from a title of each of the plurality of contents; and
an instruction for generating the index information by mapping the extracted keyword and titles of the plurality of contents.

18. The system of claim 12, wherein the index information comprises an index keyword and a list of contents in a mapping relationship with the index keyword, and
wherein the instruction for providing the chatbot service comprises:
an instruction for receiving a question sentence from a user;
an instruction for extracting a keyword from the received question sentence;
an instruction for obtaining a list of contents corresponding to the extracted keyword by using the index information; and
an instruction for providing a response to the received question sentence based on the obtained list.

19. The system of claim 18, wherein the instruction for providing the response comprises:
an instruction for providing contents of content corresponding to the extracted keyword as the response when a number of contents included in the obtained list is one.

20. The system of claim 12, wherein the instruction for providing the chatbot service comprises:
an instruction for providing a list of content groups to a user based on the grouping information;
an instruction for receiving a selection input for an interest content group included in the provided list from the user; and
an instruction for providing a list of contents belonging to the interest content group as a response in response to the selection input.
